(19) United States
(12) Patent Application Publication
(10) Pub. No.: US 2014/0122517 A1
(43) Pub. Date: May 1, 2014

(54) CONTACT LIST BASED ON INTERNAL AND EXTERNAL DATA

(71) Applicant: Vlad Vendrow, Redwood City, CA (US)

(72) Inventor: Vlad Vendrow, Redwood City, CA (US)

(21) Appl. No.: 13/660,794

(22) Filed: Oct. 25, 2012

(51) Int. Cl. G06F 17/30

(52) U.S. Cl. 707/769; 707/E17.014

(57) ABSTRACT

A method that allows users of telecommunications terminals to have relevant contact information presented to them without some of the disadvantages of the prior art is disclosed.

In accordance with the illustrative embodiment of the present invention, a telecommunications terminal sends a query to a data-processing system requesting contact information, and that data-processing system aggregates contact information from itself and other sources. It then sorts that contact information and sends the sorted contact information back to the telecommunications terminal.

### CROSS REFERENCE TO RELATED APPLICATIONS

This application is related to V. Vendrow, U.S. patent application Ser. No. 13/399,343, “Shared Directory System.” The underlying concepts, but not necessarily the language, are incorporated by reference.

If there are any contradictions or inconsistencies in language between this application and the case that has been incorporated by reference that might affect the interpretation of the claims in this case, the claims in this case should be interpreted to be consistent with the language in this case.

### FIELD OF THE INVENTION

The present invention relates to telecommunications in general, and, more particularly, to contact information and to the organization of contact information.

### BACKGROUND OF THE INVENTION

Individuals and organizations need to communicate with one another. Typically users use telecommunications terminals, such as mobile telephones, smartphones, personal computers, or tablet computers. These devices are capable of communicating over telecommunications networks, like the Internet, to one another and to data-processing systems, such as servers.

Previously, users had to rely on their own memories, written address books, or published telephone directories, such as the “yellow pages” or “white pages” books, to get the contact information for individuals and organizations that these users wanted to contact. Currently, users increasingly use contact lists stored on their telecommunications terminals, web search technologies, and social networks.

For the purpose of this specification, the term “contact information” is defined as information utilized for the contacting of an individual, an organization, or a device belonging to the individual or organization. For example and without limitation, contact information may be the name of an individual or organization, a physical address, an Internet Protocol (IP) address, an e-mail address, a telephone number, a World Wide Web (“web”) address, etc.

As these telecommunications terminals become more sophisticated, users find that the capabilities of these discrete techniques to find contact information lack integration and utility for the users.

There exists a need to combine these telecommunications technologies in a way that provides utility for users.

### SUMMARY OF THE INVENTION

The present invention provides a solution that allows users of telecommunications terminals to have relevant contact information presented to them without some of the disadvantages of the prior art.

In accordance with the illustrative embodiment of the present invention, a telecommunications terminal sends a query to a data-processing system requesting contact information, and that data-processing system aggregates contact information from its own data-storage system, which may comprise a database, and other sources. It then sorts that contact information and sends the sorted contact information back to the telecommunications terminal. Alternatively, the data-processing system can aggregate the contact information in advance of a query.

The data-processing system sends queries of its own to other data-processing systems such as online telephone directories, such as the “white pages” or “yellow pages,” Google Local or yp.com, social networks such as, Facebook, Twitter, or Google Plus, any listing of individuals, organizations, businesses and/or their telecommunications terminals and data-processing systems, and even other telecommunications terminals and their contact lists.

The data-processing system then orders the contact information in a way that is relevant to the user and transmits it to the user's telecommunications terminal. It does this by taking into account factors including, but not limited to: the time of the request, the location of the telecommunications terminal, and the relationship of the requesting user and the individuals and organizations requested. The data-processing system also takes the privacy settings of those individuals and organizations requested before transmitting any contact information.

It will also be clear to one skilled in the art, after reading this disclosure, how to make and use alternative embodiments of the present invention in which the contact information is aggregated in a different manner, for example and without limitation, where the telecommunications terminal aggregates the information itself.

### BRIEF DESCRIPTION OF THE DRAWINGS

FIG. 1 depicts a schematic diagram of a portion of telecommunications system 100 in accordance with the illustrative embodiment of the present invention.

FIG. 2 depicts a schematic diagram of a portion of telecommunications system 100 in accordance with the illustrative embodiment of the present invention.

FIG. 3 depicts a schematic diagram of a portion of telecommunications system 100 in accordance with the illustrative embodiment of the present invention.

FIG. 4 depicts a schematic diagram of a portion of telecommunications system 100 in accordance with the illustrative embodiment of the present invention.

FIG. 5 depicts a schematic diagram of data-processing system 104-a in accordance with the illustrative embodiment of the present invention.

FIG. 6a depicts a flowchart of the salient tasks associated with the operation of the illustrative embodiment of the present invention.

FIG. 6b depicts a flowchart of the salient tasks associated with the operation of an alternative embodiment of the present invention.

FIG. 7 depicts a flowchart of the salient tasks associated with task 403 in accordance with the illustrative embodiment of the present invention.

FIG. 8 depicts a flowchart of the salient tasks associated with task 702 in accordance with the illustrative embodiment of the present invention.

FIG. 9 depicts a flowchart of the salient tasks associated with task 703 in accordance with the illustrative embodiment of the present invention.

FIG. 10 depicts a flowchart of the salient tasks associated with task 703 in accordance with the illustrative embodiment of the present invention.

FIG. 11a depicts an implementation of an address book in accordance with the prior art.

FIG. 11b depicts an implementation of an address book in accordance with the illustrative embodiment of the present invention.

### DETAILED DESCRIPTION

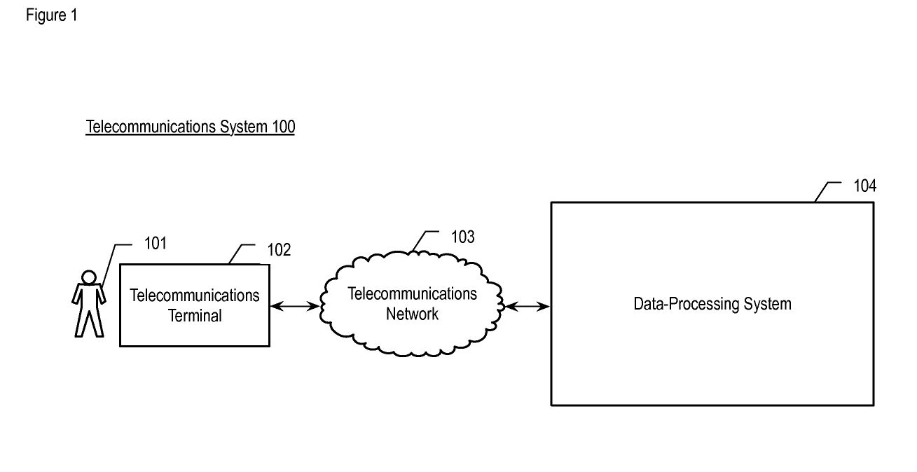

FIG. 1 depicts a schematic diagram of a portion of telecommunications system 100 in accordance with the illustrative embodiment of the present invention. Telecommunications system 100 comprises user 101, telecommunications terminal 102, telecommunications network 103, and data-processing system 104.

Although telecommunications network comprises one (1) user, it will be clear to one skilled in the art, after reading this disclosure, how to make and use alternative embodiments of the present invention in which there are any number of users.

Although telecommunications network comprises one (1) telecommunications terminal, it will be clear to one skilled in the art, after reading this disclosure, how to make and use alternative embodiments of the present invention in which there are any number of telecommunications terminals.

Although telecommunications network comprises one (1) telecommunications network, it will be clear to one skilled in the art, after reading this disclosure, how to make and use alternative embodiments of the present invention in which there are any number of telecommunications networks.

Although telecommunications network comprises one (1) data-processing system, it will be clear to one skilled in the art, after reading this disclosure, how to make and use alternative embodiments of the present invention in which there are any number of data processing centers.

Telecommunications terminal 102 hardware and software for communicating on a telecommunications network. In accordance with the illustrative embodiment of the present invention, telecommunications terminal 102 can be either wireline terminals or wireless terminals, or a combination of both.

Telecommunications network 103 is a public network, such as the Internet, but it will be clear to those skilled in the art, after reading this disclosure, how to make and use alternative embodiments of the present invention in which telecommunication network 103 is another network, for example and without limitation, a private telephone network, the Public Switched Telephone Network, a private data network, a wireless network, a private branch exchange, a satellite network, etc.

Data-processing system 104 is hardware and software for coordinating communication with between the telecommunications terminals and the telecommunications network. It will be clear to one skilled in the art, after reading this disclosure, how to make and use data processing system 103.

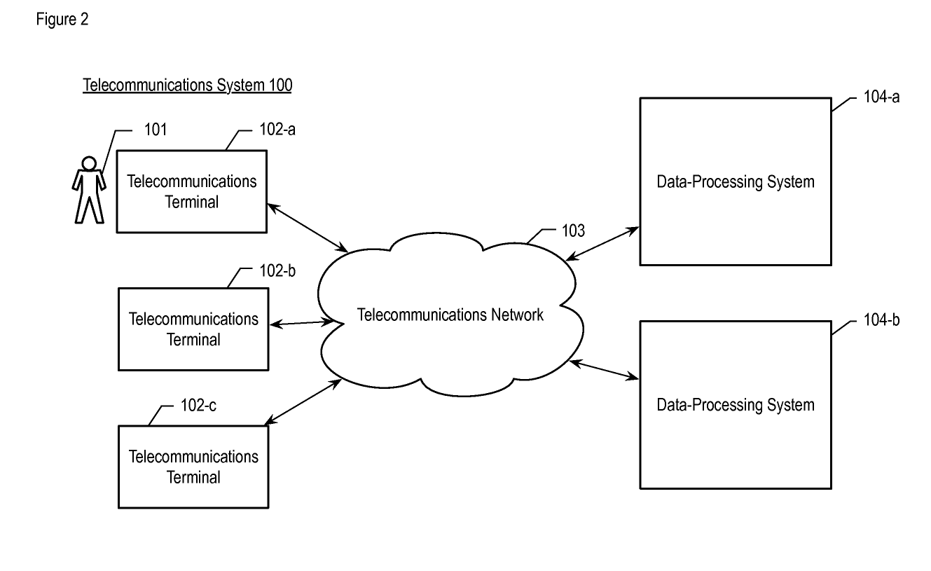

FIG. 2 depicts a schematic diagram of a portion of telecommunications system 100 in accordance with the illustrative embodiment of the present invention. Telecommunications system 100 comprises user 101, telecommunications terminals 102-a through 102-c, telecommunications network 103, and data-processing systems 104-a and 104-b.

Although telecommunications network comprises one (1) user, it will be clear to one skilled in the art, after reading this disclosure, how to make and use alternative embodiments of the present invention in which there are any number of users.

Although telecommunications network comprises three (2) telecommunications terminals, it will be clear to one skilled in the art, after reading this disclosure, how to make and use alternative embodiments of the present invention in which there are any number of telecommunications terminals.

Although telecommunications network comprises one (1) telecommunications network, it will be clear to one skilled in the art, after reading this disclosure, how to make and use alternative embodiments of the present invention in which there are any number of telecommunications networks.

Although telecommunications network comprises one (1) data-processing system, it will be clear to one skilled in the art, after reading this disclosure, how to make and use alternative embodiments of the present invention in which there are any number of data processing centers.

Telecommunications terminal 102-a, telecommunications terminal 102-b, and telecommunications terminal 102-c are each hardware and software for communicating on a telecommunications network. In accordance with the illustrative embodiment of the present invention, telecommunications terminal 102 can be either wireline terminals or wireless terminals, or a combination of both. Examples of telecommunications terminals include, but are not limited to: computers, mobile telephones, wired or wireline telephones, televisions or television set-top boxes, or any device that can communicate on a telecommunications network.

Telecommunications network 103 is a public network, such as the Internet, but it will be clear to those skilled in the art, after reading this disclosure, how to make and use alternative embodiments of the present invention in which telecommunication network 103 is another network, for example and without limitation, a private telephone network, the Public Switched Telephone Network, a private data network, a wireless network, a private branch exchange, a satellite network, etc.

Data-processing system 104-a and data-processing system 104-b are each hardware and software for coordinating communication with between the telecommunications terminals and the telecommunications network. It will be clear to one skilled in the art, after reading this disclosure, how to make and use data-processing system 104.

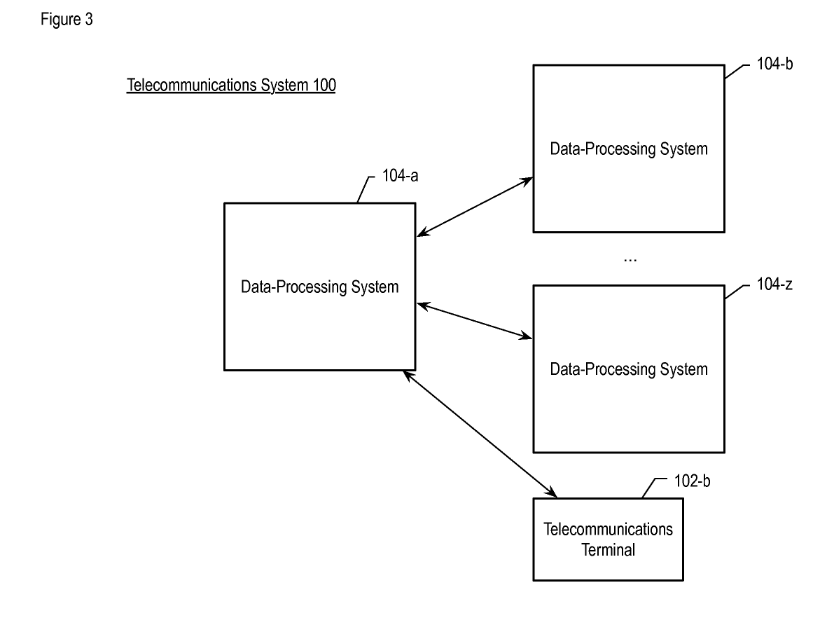

FIG. 3 depicts a schematic diagram of a portion of telecommunications system 100 in accordance with the illustrative embodiment of the present invention. Telecommunications system 100 comprises data-processing system 104-a, data-processing systems 104-a through 104-z and telecommunications terminal 102-b.

Although telecommunications network comprises twenty-six (26) data-processing systems and displays only three (3), it will be clear to one skilled in the art, after reading this disclosure, how to make and use alternative embodiments of the present invention in which there are any number of data-processing systems.

Although telecommunications network comprises one (1) telecommunications terminal, it will be clear to one skilled in the art, after reading this disclosure, how to make and use alternative embodiments of the present invention in which there are any number of telecommunications terminals.

Although this portion of telecommunications system 100 omits the depiction of a telecommunications network, it will be clear to one skilled in the art, after reading this disclosure, how to make and use alternative embodiments of the present invention in which data-processing system 104-a connects to the other devices by the use of one or more telecommunications networks.

In accordance with the illustrative embodiment of the present invention, data-processing system 104-b is a contact directory such as a telephone directory. However, it will be clear to one skilled in the art, after reading this disclosure, how to make and use alternative embodiments of the present invention in which the telephone directory is one, for example and without limitation: a public telephone directory, such as the “white pages” or “yellow pages,” an online telephone directory, such as a Google Local or yp.com, or any listing of individuals, organizations, businesses and/or their telecommunications terminals and data-processing systems.

It will be clear to one skilled in the art, after reading this disclosure, how to make and use alternative embodiments of the present invention in which data-processing system 104-b is another form of directory, such as a social network or an internal organization directory.

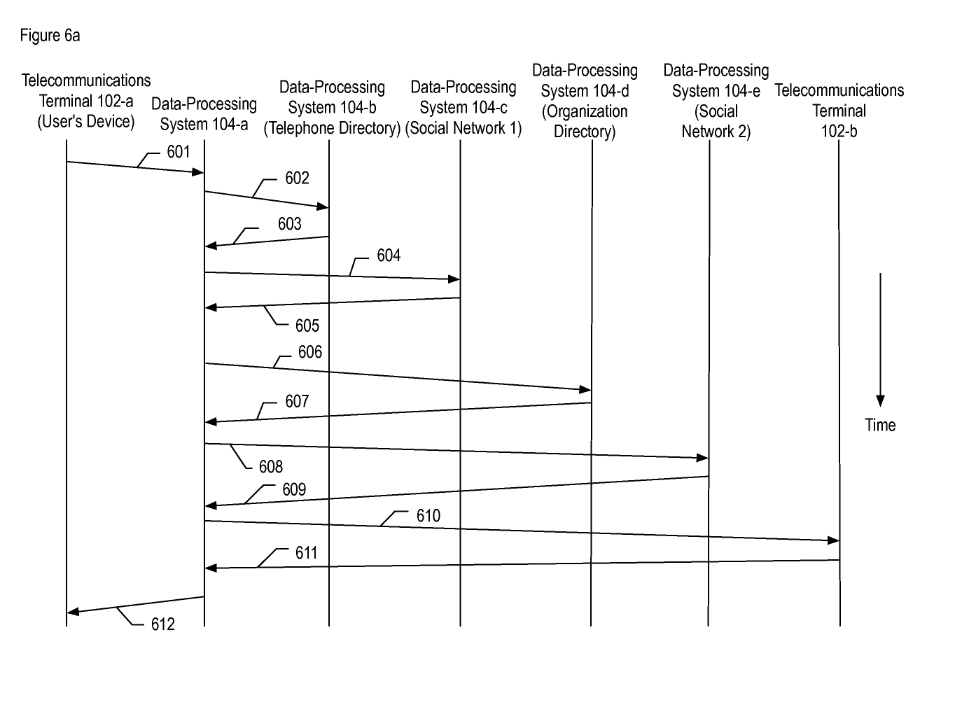

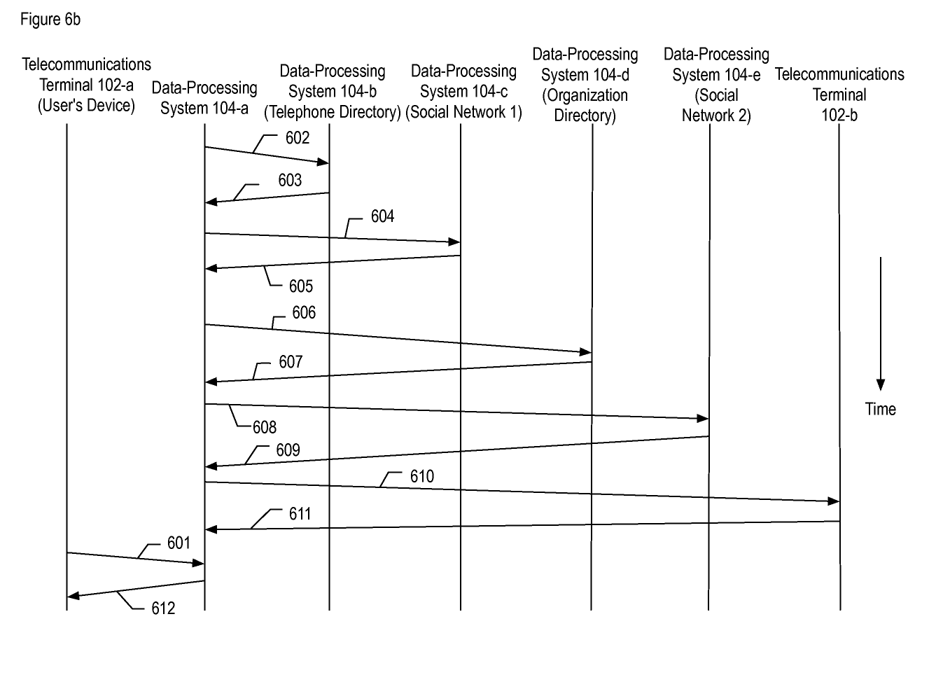

Data-processing system 104-b can be queried by data-processing system 104-a for contact information about a particular individual, organization, business, etc. For example, telecommunications terminal 102-a sends a query to data-processing system 104-a requesting the contact information for the user of telecommunications terminal 102-b. This could be the user's telephone number, e-mail address, physical address, etc. Data-processing system could then query data-processing system 104-b or any other data-processing system or telecommunications terminal. The process by which this contact information is aggregated and disseminated is described, infra, with regard to FIGS. 6 through 11b.

In accordance with the illustrative embodiment of the present invention, data-processing system 104-z is a social network such as, for example and without limitation: Facebook, Twitter, Google Plus, a social network internal to an organization, or any other network. Social networks frequently employ personal information including contact information on individuals and organizations. Individuals list information about themselves such as their names, e-mail addresses, telephone numbers, birthdays, physical addresses, etc. Additionally businesses and other organizations list information such as their names, e-mail addresses, telephone numbers, business hours, physical addresses, etc. The system can take into account not only current but also former contact information of individuals or organizations, such as former names, addresses, telephone numbers, employers, job titles, etc.

In accordance with the illustrative embodiment of the present invention, telecommunications terminal 102-b is a telecommunications terminal belonging to a colleague of user 101, the user of telecommunications terminal 102-a. However, it will be clear to one skilled in the art, after reading this disclosure, how to make and use alternative embodiments of the present invention in which telecommunications terminal 102-b belongs to any individual or organization.

However, it will be clear to one skilled in the art, after reading this disclosure, how to make and use alternative embodiments of the present invention in which telecommunications terminal 102-b communicates with data-processing system 104-a sending it information including, but not limited to: its internal contact directory and its own contact information (i.e. its telephone number, e-mail address).

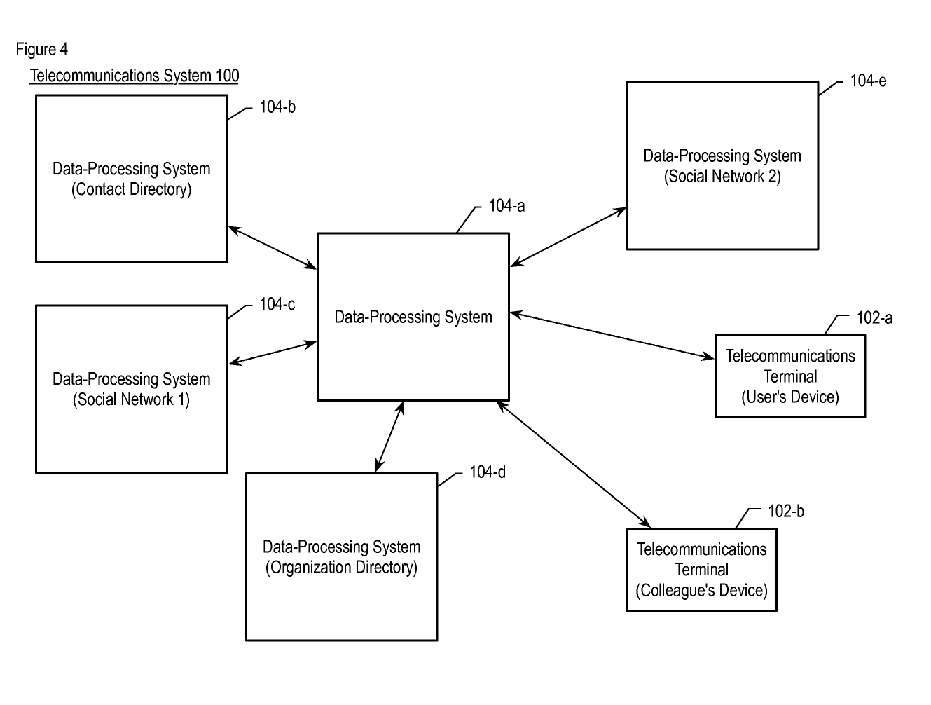

FIG. 4 depicts a schematic diagram of a portion of telecommunications system 100 in accordance with the illustrative embodiment of the present invention. Telecommunications system 100 comprises data-processing systems 104-a through 104-e and telecommunications terminals 102-a and 102-b.

Although telecommunications network comprises five (5) data-processing system, it will be clear to one skilled in the art, after reading this disclosure, how to make and use alternative embodiments of the present invention in which there are any number of data-processing systems.

Although telecommunications network comprises two (2) telecommunications terminals, it will be clear to one skilled in the art, after reading this disclosure, how to make and use alternative embodiments of the present invention in which there are any number of telecommunications terminals.

Although this portion of telecommunications system 100 omits the depiction of a telecommunications network, it will be clear to one skilled in the art, after reading this disclosure, how to make and use alternative embodiments of the present invention in which data-processing system 104-a connects to the other devices by the use of one or more telecommunications networks.

In accordance with the illustrative embodiment of the present invention, data-processing system 104-b is a contact directory such as a telephone directory. However, it will be clear to one skilled in the art, after reading this disclosure, how to make and use alternative embodiments of the present invention in which the telephone directory is one, for example and without limitation: a public telephone directory, such as the “white pages” or “yellow pages,” an online telephone directory, such as a Google Local or yp.com, or any listing of individuals, organizations, businesses and/or their telecommunications terminals and data-processing systems.

It will be clear to one skilled in the art, after reading this disclosure, how to make and use alternative embodiments of the present invention in which data-processing system 104-b is another form of directory, such as a social network or an internal organization directory.

Data-processing system 104-b can be queried by data-processing system 104-a for contact information about a particular individual, organization, business, etc. For example, telecommunications terminal 102-a sends a query to data-processing system 104-a requesting the contact information for the user of telecommunications terminal 102-b. This could be the user's telephone number, e-mail address, physical address, etc. Data-processing system could then query data-processing system 104-b or any other data-processing system or telecommunications terminal. The process by which this contact information is aggregated and disseminated is described, infra, with regard to FIGS. 6 through 11b.

In accordance with the illustrative embodiment of the present invention, data-processing system 104-c is a social network such as, for example and without limitation: Facebook, Twitter, Google Plus, a social network internal to an organization, or any other network. Social networks frequently employ personal information including contact information on individuals and organizations. Individuals list information about themselves such as their names, e-mail addresses, telephone numbers, birthdays, physical addresses, etc. Additionally businesses and other organizations list information such as their names, e-mail addresses, telephone numbers, business hours, physical addresses, etc.

In accordance with the illustrative embodiment of the present invention, data-processing system 104-d is an organization directory such as an internal telephone directory. However, it will be clear to one skilled in the art, after reading this disclosure, how to make and use alternative embodiments of the present invention in which the organization directory is another directory.

In accordance with the illustrative embodiment of the present invention, data-processing system 104-e is a social network such as, for example and without limitation: Facebook, Twitter, Google Plus, a social network internal to an organization, or any other network.

In accordance with the illustrative embodiment of the present invention, telecommunications terminal 102-b is a telecommunications terminal belonging to a colleague of user 101, the user of telecommunications terminal 102-a. However, it will be clear to one skilled in the art, after reading this disclosure, how to make and use alternative embodiments of the present invention in which telecommunications terminal 102-b belongs to any individual or organization.

However, it will be clear to one skilled in the art, after reading this disclosure, how to make and use alternative embodiments of the present invention in which telecommunications terminal 102-b communicates with data-processing system 104-a sending it information including, but not limited to: its internal contact directory and its own contact information (i.e. its telephone number, e-mail address).

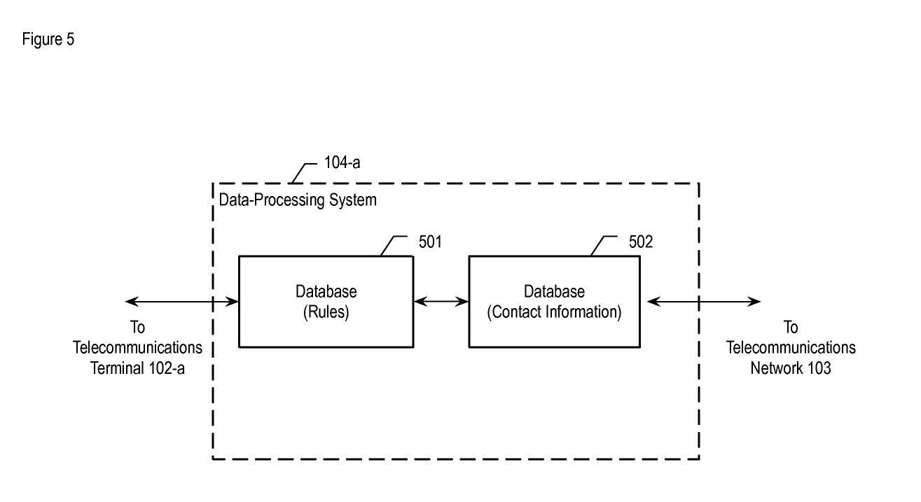

FIG. 5 depicts a schematic diagram of data-processing system 104-a in accordance with the illustrative embodiment of the present invention. Data-processing system 104-a comprises database 501 and database 502.

Although data-processing system 104-a comprises two separate databases, it will be clear to one skilled in the art, after reading this disclosure, how to make and use alternative embodiments of the present invention in which data-processing system 104-a comprises any number of databases.

Although data-processing system 104-a is depicted as comprising only two separate databases, it will be clear to one skilled in the art, after reading this disclosure, that data-processing system 104-a comprises hardware, software, and memory storage devices. It will be clear to one skilled in the art, after reading this disclosure, how to make and use data-processing system 104-a.

Although data-processing system 104-a is depicted as connecting directly to telecommunications terminal 102-a it will be clear to one skilled in the art, after reading this disclosure, how to make and use alternative embodiments of the present invention in which data-processing system 104-a connects to telecommunications terminal 102-a or other device by use of telecommunications network 103 or any other telecommunications network.

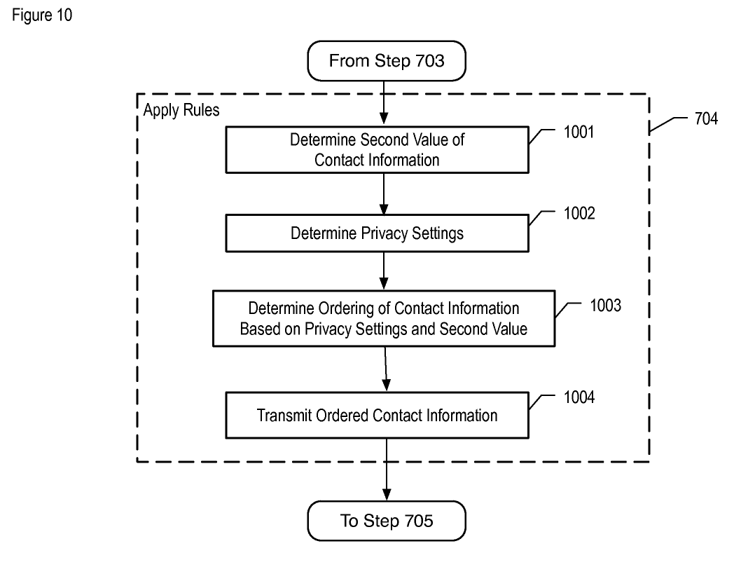

Database 501 consists of a set of rules that determine which contact information contained in database 502 should be sent to telecommunications terminal 102-a. The rules contained in database 501 and their use are described, infra, when discussing FIG. 10.

Database 502 contains stored contact information and contact information retrieved from various sources. With reference to FIG. 4, database 502 aggregates the contact information from the various sources listed in FIG. 4. Database 502 then stores the contact information and makes it available to queries from database 501, telecommunications terminal 102-a and other approved query sources.

FIG. 6a depicts a flowchart of the salient tasks associated with the operation of the illustrative embodiment of the present invention.

Although, in accordance with the illustrative embodiment of the present invention, task 601 is performed at telecommunications terminal 102-a, it will be clear to one skilled in the art, after reading this disclosure, how to make and use other implementations of the present invention in which the steps are performed by another device as part of telecommunications system 100 including, but not limited to: a telecommunications terminal or a different data-processing system. It will be clear to one skilled in the art, after reading this disclosure, how to implement the tasks in FIG. 6a.

Although, in accordance with the illustrative embodiment of the present invention, tasks 602 to 612 are performed at data-processing system 104-a, it will be clear to one skilled in the art, after reading this disclosure, how to make and use other implementations of the present invention in which the steps are performed by another device as part of telecommunications system 100 including, but not limited to: a telecommunications terminal or a different data-processing system. It will be clear to one skilled in the art, after reading this disclosure, how to implement the tasks in FIG. 6a.

Although, in accordance with the illustrative embodiment of the present invention, FIG. 6a shows how to perform the salient tasks associated with the operation of the illustrative embodiment of the present invention with twelve (12) messages, it will be clear to one skilled in the art, after reading this disclosure, how to implement the present invention for any number of messages. Furthermore, it is the intention that the illustrative embodiment of the present invention be used with a very large number of messages and these messages comprise a series of queries and responses.

Although, in accordance with the illustrative embodiment of the present invention, tasks 601 to 612 are performed sequentially, it will be clear to one skilled in the art, after reading this disclosure, how to make and use alternative embodiments of the present invention in which tasks 601 to 612 are performed in any order. In an alternative embodiment, for example and without limitation, tasks 602 to 611 may be performed in data aggregation processes prior to steps 601 and 612. Queries by telecommunications terminal 102-a can then be answered without it having to communicate with a plurality of data-processing systems and/or telecommunications terminals.

At task 601, telecommunications terminal 102-a sends a first message to data-processing system 104-a. In accordance with the illustrative embodiment of the present invention, the message in task 601 comprises a first query to data-processing system 104-a. Additionally, this message may comprise other information, including but not limited to: contact information possessed by telecommunications terminal 102-a, information detailing a relationship between user 101 and a user of a second telecommunications terminal, a relationship between telecommunications terminal 102-a and a particular organization, etc.

At task 602, data-processing system 104-a sends a query to data-processing system 104-b. This query will be similar to that of task 601. Data-processing system 104-a sends a message that asks for contact information from data-processing system 104-b.

In accordance with the illustrative embodiment of the present invention, data-processing system 104-b is a contact directory such as a telephone directory, such as the “white pages” or “yellow pages,” an online telephone directory, such as a Google Local or yp.com, or any listing of individuals, organizations, businesses and/or their telecommunications terminals and data-processing systems.

At task 603, data-processing system 104-b sends a message to data-processing system 104-a. This message will be a response to the query sent at task 602.

In accordance with the illustrative embodiment of the present invention, the response will be contact information about the person, organization, or device that is being queried. The response may also be that no such contact information is found.

At task 604, data-processing system 104-a sends a query to data-processing system 104-c. This query will be similar to that of tasks 601 and 602. Data-processing system 104-a sends a message that asks for contact information from data-processing system 104-c.

In accordance with the illustrative embodiment of the present invention, data-processing system 104-c is a social network such as, for example and without limitation: Facebook, Twitter, Google Plus, a social network internal to an organization, or any other network. Social networks frequently employ personal information including contact information on individuals and organizations. Individuals list information about themselves such as their names, e-mail addresses, telephone numbers, birthdays, physical addresses, etc. Additionally businesses and other organizations list information such as their names, e-mail addresses, telephone numbers, business hours, physical addresses, etc.

This information is especially useful because users of social networks frequently update their contact information and contact other users through the social networks themselves. This contact information may be more up to date than contact information from sources such as the white pages. The relative dating and reliability of this information is discussed further, infra, with regard to FIG. 10.

At task 605, data-processing system 104-c sends a message to data-processing system 104-a. This message will be a response to the query sent at task 604.

At task 606, data-processing system 104-a sends a query to data-processing system 104-d. This query will be similar to that of tasks 601, 602, and 604. Data-processing system 104-a sends a message that asks for contact information from data-processing system 104-d. In accordance with the illustrative embodiment of the present invention, data-processing system 104-d is an organization directory such as an internal telephone directory.

At task 607, data-processing system 104-d sends a message to data-processing system 104-a. This message will be a response to the query sent at task 606.

At task 608, data-processing system 104-a sends a query to data-processing system 104-e. This query will be similar to that of tasks 601, 602, 604, and 606. Data-processing system 104-a sends a message that asks for contact information from data-processing system 104-e.

In accordance with the illustrative embodiment of the present invention, data-processing system 104-e is a social network such as, for example and without limitation: Facebook, Twitter, Google Plus, a social network internal to an organization, or any other network. In accordance with the illustrative embodiment of the present invention, data-processing system 104-e is a different social network than that of data-processing system 104-c.

At task 609, data-processing system 104-e sends a message to data-processing system 104-a. This message will be a response to the query sent at task 608.

At task 610, data-processing system 104-a sends a query to telecommunications terminal 102-b. In accordance with the illustrative embodiment of the present invention, telecommunications terminal 102-b belongs to a colleague of user 101, the user of telecommunications terminal 102-a, which initiated the query of task 601. However, it will be clear to one skilled in the art, after reading this disclosure, how to make and use alternative embodiments of the present invention in which telecommunications terminal 102-b belongs to any individual or organization. This query will be similar to that of tasks 601, 602, 604, 606, and 608.

At task 611, telecommunications terminal 102-b sends a message to data-processing system 104-a. This message will be a response to the query sent at task 610.

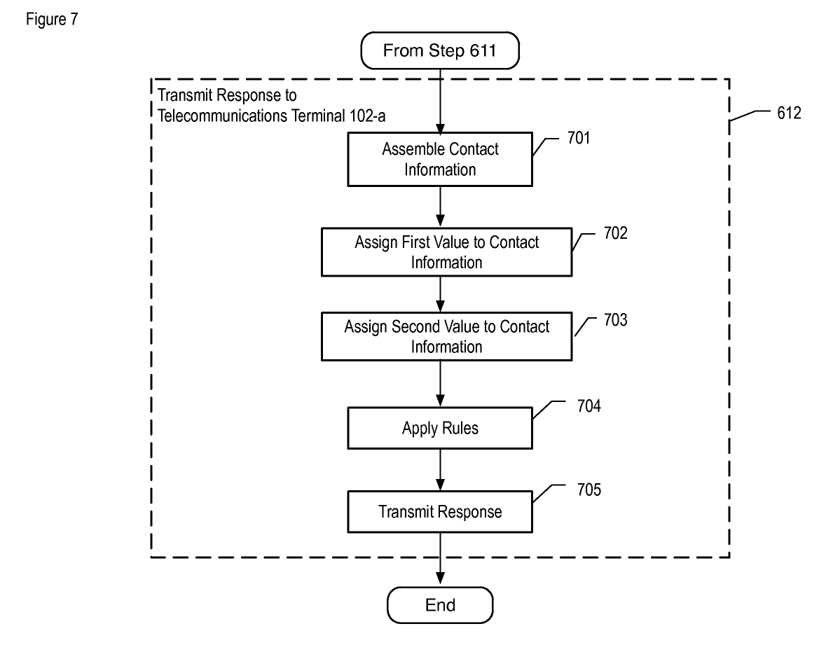

At task 612, data-processing system 104-a sends a message to telecommunications terminal 102-b. This message will be a response to the query sent at task 610. Task 612 is described in greater detail, infra, with regard to FIG. 7.

It will be clear to one skilled in the art, after reading this disclosure, how to make and use other implementations of the present invention in which one or more of the steps are omitted or are performed in a different order than the one presented or simultaneously.

FIG. 6b depicts a flowchart of the salient tasks associated with the operation of an alternative embodiment of the present invention. The tasks performed in FIG. 6b are similar to those performed in FIG. 6a. For illustrative purposes, task 601 is now performed after task 611 and before task 612.

It will be clear to one skilled in the art, after reading this disclosure, how to make and use other implementations of the present invention in which one or more of the steps are omitted or are performed in a different order than the one presented or simultaneously.

FIG. 7 depicts a flowchart of the salient tasks associated with task 403 in accordance with the illustrative embodiment of the present invention. At task 612, data-processing system 104-a sends a message to telecommunications terminal 102-b.

At task 701, the contact information received from the other data-processing systems and telecommunications terminals.

Although task 701 is performed after tasks 601 through 611 are performed, it will be clear to one skilled in the art, after reading this disclosure, how to make and use alternative embodiments of the present invention in which task 701 is performed at some other time, for example and without limitation, after receiving contact information at task 603, performed continuously throughout the process, or performed after a data aggregation process that aggregates data from a plurality of data-processing systems and/or telecommunications terminals into a single data-processing system.

TABLE 1
Simplified Illustration of Contact Information

| Source # | Contact Information |
|---|---|
| 1 | Phone Number 1 |
| 1 | Address Number 1 |
| 2 | Phone Number 2 |
| 3 | E-mail Address 1 |
| . . . | . . . |
| 9 | E-mail Address 3 |

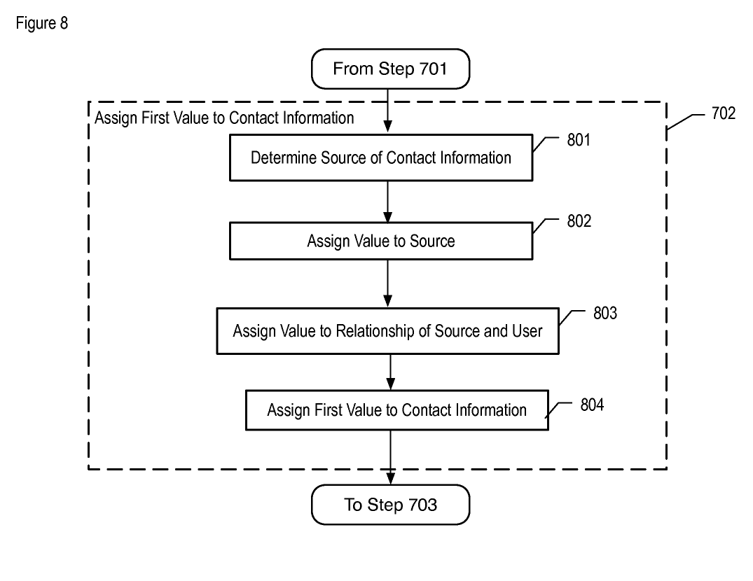

At task 702, a first value is assigned to each piece of contact information received in tasks 602 through 611. This task is described in greater detail in FIG. 8.

It will be clear to one skilled in the art, after reading this disclosure, how to make and use other implementations of the present invention in which one or more of the steps are omitted or are performed in a different order than the one presented or simultaneously.

FIG. 8 depicts a flowchart of the salient tasks associated with task 702 in accordance with the illustrative embodiment of the present invention.

At task 801, the source of contact information is determined. In accordance with the illustrative embodiment of the present invention, the sources of contact information will be known to data-processing system 104-a. However, it will be clear to one skilled in the art, after reading this disclosure, how to make and use alternative embodiments of the present invention in which a determination must be made.

At task 802, a value is assigned to each source. Because the contact information is received from a variety of sources, the information received is given relative values based on a variety of factors. These factors include but are not limited to: the trust value associated with the source, how frequently the source is updated, the methods by which the sources accumulate their contact information, etc.

TABLE 2
Illustration of Values Assigned to Source

| Source # | Source Name | Source Value |
|---|---|---|
| 1 | Telephone Directory | S₁ |
| 2 | Social Network 1 | S₂ |
| 3 | Organization Directory | S₃ |
| 4 | Social Network 2 | S₄ |
| 5 | Telecommunications Terminal 2 | S₅ |
| 6 | Telecommunications Terminal 1 | S₆ |

As illustrated in table 2, each source has a value assigned to it. Each source value is used in the calculation of the first value, as illustrated with regard to task 804.

At task 803, a value is assigned to the relationship between the source and the user.

In accordance with the illustrative embodiment of the present invention, a relationship value is determined based on factors including but not limited to: a business or personal relationship between the users of telecommunications terminal 102-a and 102-b, the number of degrees of separation between two users of a social network, the relationship between two individuals in an organization (such as co-workers), the size of a social network to which the users belong, etc.

In some embodiments, the relationship value can be based in part on a relationship between two users of a social network. For example and without limitation this relationship can be measured as the degrees of separation between the two users of the social network.

Additionally, relationship information, such as links between users in social networks or in a user or organization's address book can be used to determine a relationship value. For example the relationships and values can be determined from a series of relationships, such as friend, professional colleague, or links across address books. These relationship sources include but are not limited to address book entries, and a “favorite” address book entries, but also take into account hidden or virtual links between users. These hidden or virtual links can be where a first user links to second user whose relationships may be relevant to the first user's queries for contact information with or without creating a visible or explicit relationship between the first user and the second user.

In another example, relationship information can be determined from a user's “favorites” or “bookmarks.” Typically, a user may mark a contact in their address book, a website, or a file on his or her computer as a “favorite” or “bookmark it.” When a user does this, it does not necessarily create a relationship between the two parties, like a “friending” on a social network may. When a social network pairing or “friending” is made, both parties agree to forge a relationship on that network. A relationship of a bookmark or favorite is one-sided. The user designates a particular second user or organization as more important or more relevant than other users and organizations. This information is relevant relationship information.

Furthermore, this information can be used not only to determine relationship information for the user who selects the favorites, but for other users and organizations. For example and without limitation, those users and organizations that are frequently selected as favorites, can be given greater relationship values than those less frequently selected. Also, those selected as favorites by users close to the selected user, can be given higher priority even if the user him or herself has not selected that user or organization as a favorite. For example and without limitation, a user, “George,” has a friend, “Ringo,” who selects the Abbey Road Studio as a favorite. Because Ringo has selected Abbey Road Studio as a favorite, a relationship is formed with George as well.

In another example, a user or organization can be blocked from the search results of a particular user and/or that user or organization can be marked for abuse of the system. Those users and organizations that are frequently blocked or marked for abuse can be given lesser relationship values than those less frequently blocked or marked for abuse, and those blocked or marked for abuse by users close to the selected user can be given lesser relationship values even if the user him or herself has not blocked or marked for abuse those users or organizations.

In another example, hidden links can be created when one user performs a search for a contact such that the relationship value can take into account whether a contact has previously searched for the user performing the query, or vice versa, i.e., the relationship value can be based in part on search histories of users. For example and without limitation, if a user has searched for a particular type of business in the past, similar businesses—even if the user has never searched for that business—may be given a priority. For example, a user frequently searches for shoe shine or repair stores, but is traveling and is located in a city with which the user is unfamiliar, a local shoe shine or repair store may be given priority in a contact listing for a user.

In another example, the relationship value may take into account the number of users linking to a given user, the number of users linking to those users, etc. such that users with more links may have a higher relationship value than other users, all other factors equal.

In another example, the source value and/or the relationship value may take into account tags for a particular contact assigned by the user or another user.

For the purpose of this specification, the term “tag” is defined as a keyword, phrase, or term assigned to a piece of information, for example and without limitation, a digital file, an internet bookmark, digital image, video, etc. In another example, tags may be automatically added by the system, such as a tag to indicate that a particular contact has registered an account with the system or a tag to indicate that a particular contact has been manually added, edited, or corrected on the system, in which case those tags may affect the source value of the contact. In another example, contact information that has been marked as incorrect may be automatically removed from the system or given a significantly lower source value.

To continue with the shoe shine or repair example, if the user were to tag the location with tags such as: “shoes,” “shine,” “great work,” etc., then searches for those keywords or phrases would be more likely to include the location in their results. Furthermore, other contacts with those tags or similar tags would be considered more relevant to that user. In a similar vein, identical or similar tags applied by other users to their contacts would be relevant relationship information for the user. In addition, tags can be used to filter search results.

These links, explicit, hidden, virtual, etc., will be collectively calculated to determine a relationship value at task 803. It will be clear to one skilled in the art, after reading this disclosure, how to make and use other implementations of the present invention that implement task 803 as described herein or in a different manner than described.

At task 804, a first value is assigned to the contact information. Table 3 is a simplified illustration of the first value being assigned to the contact information.

TABLE 3
Illustration of Contact Information with First Value

| | Source | | | First |
|---|---|---|---|---|
| Index # | # | Source Name | Contact Information | Value |
| 1 | 1 | Telephone Directory | Phone Number 1 | V₁ |
| 2 | 1 | Telephone Directory | Physical Address 1 | V₂ |
| 3 | 2 | Social Network 1 | Phone Number 2 | V₃ |
| 4 | 3 | Organization Directory | E-mail Address 1 | V₄ |
| 5 | 3 | Organization Directory | Physical Address 2 | V₅ |
| 6 | 4 | Social Network 2 | E-mail Address 2 | V₆ |
| 7 | 5 | Telecommunications | Phone Number 3 | V₇ |
| | | Terminal 2 | | |
| 8 | 6 | Telecommunications | Instant Messaging 1 | V₈ |
| | | Terminal 1 | | |

In accordance with the illustrative embodiment of the present invention, the first value is assigned as a product of a function. The function has as inputs various values including, but not limited to: the value of the source, a relationship value, a value assigned to information originating from the requesting telecommunications terminal, etc.

A mathematical illustration of this function is as follows:

Vᵢ=f(Sᵢ,Rᵢ, . . . )

### Formula 1: First Value Function

Where Vᵢ is the first value, Sᵢ is the value assigned to the source, Rᵢ is the value assigned to the relationship.

TABLE 4
Illustration of Contact Information with First Value

| | | Source | Relationship | |
|---|---|---|---|---|
| Index # | Contact Information | Value | Value | First Value |
| 1 | Phone Number 1 | S₁ | R₁ | V₁ |
| 2 | Physical Address 1 | S₁ | R₂ | V₂ |
| 3 | Phone Number 2 | S₁ | R₃ | V₃ |
| 4 | E-mail Address 1 | S₃ | R₄ | V₄ |
| 5 | Physical Address 2 | S₃ | R₅ | V₅ |
| 6 | E-mail Address 2 | S₄ | R₆ | V₆ |
| 7 | Phone Number 3 | S₅ | R₇ | V₇ |
| 8 | Instant Messaging 1 | S₆ | R₈ | V₈ |

Table 4 is a graphical illustration of how the values may be assigned based on the input values into the function.

It will be clear to one skilled in the art, after reading this disclosure, how to make and use other implementations of the present invention in which one or more of the steps are omitted or are performed in a different order than the one presented or simultaneously.

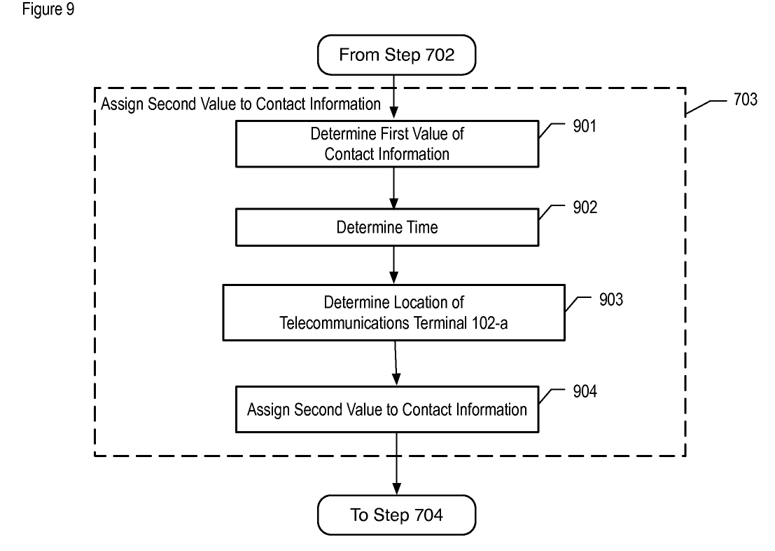

FIG. 9 depicts a flowchart of the salient tasks associated with task 703 in accordance with the illustrative embodiment of the present invention.

At task 901, the first value of the contact information is determined. In accordance with the illustrative embodiment of the present invention, the first value is determined in step 702.

At task 902, a time is determined. In accordance with the illustrative embodiment of the present invention, the time is typical date-time determination. However, it will be clear to one skilled in the art, after reading this disclosure, how to make and use alternative embodiments of the present invention in which the time is determined in a different manner.

At task 903, the location of telecommunications terminal 102-a is determined. In accordance with the illustrative embodiment of the present invention, the location is determined by global positioning system (GPS). However, it will be clear to one skilled in the art, after reading this disclosure how to make and use alternative embodiments of the present invention in which the location is determined in a different manner, for example and without limitation: correlation of Internet Protocol (IP) address and physical address, correlation of telephone number, area code, or exchange and physical address, triangulation of location based on cellular telephone towers and connection, or a combination of any of these techniques.

At task 904, a second value is assigned to the contact information based on the first value, the time, and/or the location of the device, telecommunications terminal 102-a.

In accordance with the illustrative embodiment of the present invention, the time is used to determine which contact information should be presented to the user. For example and without limitation, if the particular time of the search is during the regular business hours of a local business, then the second value of the contact information for that business should be higher. In another example, the system can prevent a user from attempting to contact an individual or business outside of certain hours by hiding the contact information outside of certain hours, graying out the contact information outside of certain hours, or displaying a warning that the user is attempting to contact the individual or business outside of waking or business hours. Users of the system may be given the option to control and set rules as to how their contact information is displayed during certain hours of the day or when they are in particular locations, as described further below.

In accordance with the illustrative embodiment of the present invention, the location of the device is used to determine the distance between telecommunications terminal 102-a and the potential contact. For example and without limitation, if user 101 wants to look up the contact information of a local business, the distances between the user and the businesses are relevant. The closer the business is to the user and the user's device, the second value of the contact information for that business should be higher.

A mathematical illustration of this function is as follows:

Wᵢ=g(Vᵢ,tᵢ,Iᵢ . . . )

### Formula 2: Second Value Function

Where Wᵢ is the second value, Vᵢ is the first value, tᵢ is the time, Iᵢ is location of the contact or the distance between the contact and the user.

TABLE 5
Illustration of Contact Information with Second Value

| | | | | Location | Second |
|---|---|---|---|---|---|
| Index # | Contact Information | First Value | Time | (Distance) | Value |
| 1 | Phone Number 1 | V₁ | t₁ | N/A | W₁ |
| 2 | Physical Address 1 | V₂ | t₁ | l₁ | W₂ |
| 3 | Phone Number 2 | V₃ | t₁ | N/A | W₃ |
| 4 | E-mail Address 1 | V₄ | t₁ | N/A | W₄ |
| 5 | Physical Address 2 | V₅ | t₁ | l₂ | W₅ |
| 6 | E-mail Address 2 | V₆ | t₁ | N/A | W₆ |
| 7 | Phone Number 3 | V₇ | t₁ | N/A | W₇ |
| 8 | Instant Messaging 1 | V₈ | t₁ | N/A | W₈ |

Table 5 is a graphical illustration of how the second values may be assigned based on the input values into the function.

TABLE 6
Illustration of Contact Information

| Contact Information | First Value |
|---|---|
| Name | Delicious Sandwiches |
| Phone Number 1 | (212) 555-7890 |
| Physical Address 1 | 123 Main St |
| | New York, NY 10003 |
| Business Hours | 6 am-7 pm |
| Name | Acceptable Pizza |
| Phone Number 1 | (718) 555-1234 |
| Physical Address 1 | 385 Stuyvesant St. |
| | Staten Island, NY 10003 |
| Business Hours | 12 pm-11 pm |
| Web Address | http://pizza.us |
| Fax Number 3 | (718) 555-1235 |
| Name | Exotic Eateries |
| Phone Number 1 | (212) 555-8855 |
| Physical Address 1 | 555 Park Ave |
| | New York, NY 10003 |
| Business Hours | 10 pm-3 am |

Table 6 is an illustration of contact information in accordance with the illustrative embodiment of the present invention. Table 6 comprises three (3) fictional businesses for illustrative purposes. It will be clear to one skilled in the art, after reading this disclosure, how to make and use alternative embodiments of the present invention in which there are any number of businesses real or fictional.

In accordance with the illustrative embodiment of the present invention, in the determination of the second value is assigned, there is a determination of the location of the first user and/or the user's telecommunications terminal, I₀, and a time.

The user location is then compared with the locations of the businesses in question. The distances between the users are compiled as locations, I₁, I₂, I₃, etc. An illustration of this addition of location information is depicted in table 7:

TABLE 7
Illustration of Contact Information with Location Determination

| | | Location |
|---|---|---|
| Contact Information | First Value | (Distance) |
| Name | Delicious Sandwiches | N/A |
| Phone Number 1 | (212) 555-7890 | N/A |
| Physical Address 1 | 123 Main St | l₁ |
| | New York, NY 10003 | |
| Business Hours | 6 am-7 pm | N/A |
| Name | Acceptable Pizza | N/A |
| Phone Number 1 | (718) 555-1234 | N/A |
| Physical Address 1 | 385 Stuyvesant St. | l₂ |
| | Staten Island, NY 10003 | |
| Business Hours | 12 pm-11 pm | N/A |
| Web Address | http://pizza.us | N/A |
| Fax Number 3 | (718) 555-1235 | N/A |
| Name | Exotic Eateries | N/A |
| Phone Number 1 | (212) 555-8855 | N/A |
| Physical Address 1 | 555 Park Ave | l₃ |
| | New York, NY 10003 | |
| Business Hours | 10 pm-3 am | N/A |

The time is then used to determine which of the businesses are open at the time the user performs a search. In the above examples of table 6 and table 7, if the user is searching for food at 10:00 am, the only eatery open would be “Delicious Sandwiches. An illustration of this addition of location information is depicted in table 8:

TABLE 8
Illustration of Contact Information After Time Value is Assigned

| | | Location |
|---|---|---|
| Contact Information | First Value | (Distance) |
| Name | Delicious Sandwiches | N/A |
| Phone Number 1 | (212) 555-7890 | N/A |
| Physical Address 1 | 123 Main St | l₁ |
| | New York, NY 10003 | |
| Business Hours | 6 am-7 pm | N/A |

Table 8 depicts the contact information relevant to the user after the determination of location and time. Although table 8 comprises one (1) entry, it will be clear to one skilled in the art, after reading this disclosure, how to make and use alternative embodiments of the present invention in which any number of entries are considered relevant to the user.

It will be clear to one skilled in the art, after reading this disclosure, how to make and use other implementations of the present invention in which one or more of the steps are omitted or are performed in a different order than the one presented or simultaneously.

FIG. 10 depicts a flowchart of the salient tasks associated with task 703 in accordance with the illustrative embodiment of the present invention.

At task 1001, the first value of the contact information is determined. In accordance with the illustrative embodiment of the present invention, the first value is determined in step 703.

At task 1002, the privacy settings for the contact information are determined. In accordance with the illustrative embodiment of the present invention, the privacy settings are received along with the contact information at steps 603, 605, 607, 609, and/or 611.

For example and without limitation, database 502 has all the relevant contact information for a particular user, telecommunications terminal, or data-processing system, but the rules in database 501 prohibit the transmission of that contact information or a portion of that contact information to user 101 or telecommunications terminal 102-a. If the rules prohibit the transmission of the contact information, then the contact information will not be transmitted at task 1004.

At task 1003, an ordering of the contact information is determined based on the second value determined at task 1001 and the privacy settings determined at task 1002. In accordance with the illustrative embodiment of the present invention, the order determined is based on the second values determined in that ordering of the higher values is placed higher in the ordering transmitted. Additionally, contact information that may not be transmitted will be removed from the contact information that is transmitted.

TABLE 9
Illustration of Contact Information with Second Value Assigned

| Index # | Second Value | Second Value |
|---|---|---|
| 1 | W₁ | 2 |
| 2 | W₂ | 5 |
| 3 | W₃ | 1 |
| 4 | W₄ | 4 |
| 5 | W₅ | 3 |
| 6 | W₆ | 7 |
| 7 | W₇ | 8 |
| 8 | W₈ | 9 |

Table 9 shows the “actual” second values assigned to the contact information.

Although the actual values in table 9 are single-digit integers, it will be clear to one skilled in the art, after reading this disclosure, how to make and use alternative embodiments of the present invention in which the values are any kind of number, for example and without limitation: any real number or any rational number.

Although the actual values in table 9 are each only used once, it will be clear to one skilled in the art, after reading this disclosure, how to make and use alternative embodiments of the present invention in which the values are repeated or used singly.

TABLE 10
Illustration of Contact Information with Ordered by Second Value
(Decreasing)

| Index # | Second Value | Second Value |
|---|---|---|
| 8 | W₈ | 9 |
| 7 | W₇ | 8 |
| 6 | W₆ | 7 |
| 2 | W₂ | 5 |
| 4 | W₄ | 4 |
| 5 | W₅ | 3 |
| 1 | W₁ | 2 |
| 3 | W₃ | 1 |

Table 10 shows the ordering of the contact information based on the second value.

TABLE 11
Illustration of Contact Information with Ordered by Second Value
(Decreasing), with Applied Privacy Settings

| Index # | Second Value | Second Value |
|---|---|---|
| 8 | W₈ | 9 |
| 7 | W₇ | 8 |
| 6 | W₆ | 7 |
| 2 | W₂ | 5 |
| 4 | W₄ | 4 |
| 5 | W₅ | 3 |
| 3 | W₃ | 1 |

Table 11 shows the ordering of the contact information based on the second value with the privacy settings applied. In this illustrative example, the contact information with index number 1 has been removed because the privacy settings prohibit its transmission to telecommunications terminal 102-a or user 101.

At task 1004, the ordered contact information is transmitted to telecommunications terminal 102-a.

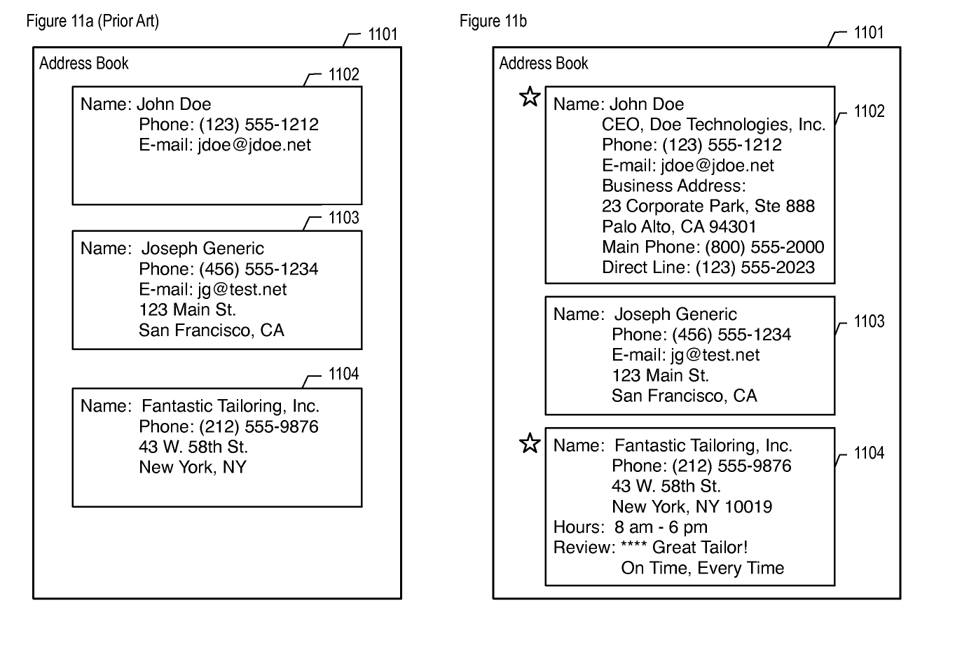

FIG. 11a depicts an implementation of an address book in accordance with the prior art. Address book 1101 comprises address-book entry 1102, address book entry 1103, and address book entry 1104.

Although address book 1101 comprises one address book on the telecommunications terminal, it will be clear to one skilled in the art, after reading this disclosure, how to make and use alternative embodiments of the present invention in which there are any number of address books on a telecommunications terminal. For example and without limitation, a single device may have multiple address books that are attached to the multiple accounts that a user may access on a single device.

Although address book 1101 comprises three address-book entries, it will be clear to one skilled in the art, after reading this disclosure, how to make and use alternative embodiments of the present invention in which there are any number of address-book entries.

The entries in FIG. 11a are illustrative and in accordance with the illustrative embodiment of the present invention. It will be clear to one skilled in the art, after reading this disclosure, how to make and use alternative embodiments of the present invention in which the address book entries are presented in a different manner than the one illustrated.

FIG. 11b depicts an implementation of an address book in accordance with the illustrative embodiment of the present invention. Address book 1101 comprises address-book entry 1102, address book entry 1103, and address book entry 1104.

Although address book 1101 comprises one address book on the telecommunications terminal, it will be clear to one skilled in the art, after reading this disclosure, how to make and use alternative embodiments of the present invention in which there are any number of address books on a telecommunications terminal. For example and without limitation, a single device may have multiple address books that are attached to the multiple accounts that a user may access on a single device.

Although address book 1101 comprises three address-book entries, it will be clear to one skilled in the art, after reading this disclosure, how to make and use alternative embodiments of the present invention in which there are any number of address-book entries.

Address-book entry 1102 and address-book entry 1104 have stars next to them in order to illustrate that they have been altered or enhanced by the methods described herein. However, it will be clear to one skilled in the art, after reading this disclosure, how to make and use alternative embodiments of the present invention in which another marking is used, for example and without limitation: no marking, an asterisk, etc.

The entries in FIG. 11b are illustrative and in accordance with the illustrative embodiment of the present invention. It will be clear to one skilled in the art, after reading this disclosure, how to make and use alternative embodiments of the present invention in which the address book entries are presented in a different manner than the one illustrated.

TABLE 12
Illustration of Address-Book Entry 1102 as Depicted in FIG. 11a

| Index # | Contact Information | Value | Source |
|---|---|---|---|
| 1 | Name | John Doe | Address Book 1101 |
| 2 | Phone Number 1 | (123) 555-1212 | Address Book 1101 |
| 3 | E-mail Address 1 | jdoe@jdoe.net | Address Book 1101 |

Table 12 illustrates an address-book entry in accordance with the prior art.

TABLE 13
Illustration of Address Book Entry 1102 as Depicted in FIG. 11b

| Index | Contact | | |
|---|---|---|---|
| # | Information | Value | Source |
| 1 | Name | John Doe | Address Book 1101 |
| 2 | Title | CEO | Doe Tech Info DB |
| 3 | Organization | Doe Technologies, Inc. | Doe Tech Info DB |
| 4 | Business Address | 23 Corporate Park | Doe Tech Info DB |
| | | Ste 888 | |
| | | Palo Alto, CA 94301 | |
| 5 | Business Phone | (800) 555-2000 | Doe Tech Info DB |
| 6 | Phone Number 1 | (123) 555-1212 | Address Book 1101 |
| 7 | E-mail Address 1 | jdoe@jdoe.net | Address Book 1101 |

Table 13 illustrates an address-book entry in accordance with the illustrative embodiment of the present invention.

At index 1, the information is the same as in table 12 and FIG. 11a.

At index 2, the information is new and completely different than the information in table 12 and FIG. 11a. The information about the title of the individual, John Doe, is taken from the database of Doe Technologies' information. It will be clear to one skilled in the art that information from other sources may be used, for example and without limitation, information provided by a social media database, such as LinkedIn, Facebook, etc.

At index 3, the information is new and completely different than the information in table 12 and FIG. 11a. The information about the name of the organization, Doe Technologies, Inc., is taken from the database of Doe Technologies' information. It will be clear to one skilled in the art that information from other sources may be used, for example and without limitation, information provided by a social media database, such as LinkedIn, Facebook, etc.

At index 4, the information is new and completely different than the information in table 12 and FIG. 11a. The address information is taken from the database of Doe Technologies' information. It will be clear to one skilled in the art that information from other sources may be used, for example and without limitation, information provided by a social media database, such as LinkedIn, Facebook, etc.

At index 5, the information is new and completely different than the information in table 12 and FIG. 11a. The telephone contact information is taken from the database of Doe Technologies' information. It will be clear to one skilled in the art that information from other sources may be used, for example and without limitation, information provided by a social media database, such as LinkedIn, Facebook, etc.

At index 6, the information is the same as in table 12 and FIG. 11a, however at a different index number. In accordance with the illustrative embodiment of the present invention, the index numbers change because the information contained in each address book entry will be organized based on the information received from the sources and on the relevance to a user. For example and without limitation, an individual's name, title, and organization would be placed above the individual's contact information.

At index 7, the information is the same as in table 12 and FIG. 11a, however at a different index number. In accordance with the illustrative embodiment of the present invention, as with index 6, the index numbers change because the information contained in each address book entry will be organized based on the information received from the sources and on the relevance to a user.

TABLE 14
Illustration of Address Book Entry 1104 as Depicted in FIG. 11a

| Index | Contact | | |
|---|---|---|---|
| # | Information | Value | Source |
| 1 | Organization | Fantastic Tailoring, Inc. | Address Book 1101 |
| 2 | Business Address | 43 W. 58^{th} St. | Address Book 1101 |
| | | New York, NY | |
| 3 | Business Phone | (212) 555-9876 | Address Book 1101 |

Table 14 illustrates an address-book entry in accordance with the prior art.

TABLE 15
Illustration of Address Book Entry 1104 as Depicted in FIG. 11b

| Index | Contact | | |
|---|---|---|---|
| # | Information | Value | Source(s) |
| 1 | Organization | Fantastic Tailoring, Inc. | Address Book 1101 |
| 2 | Business Address | 43 W. 58^{th} St. | Address Book 1101 |
| | | New York, NY 10019 | Provider Database |
| 3 | Business Phone | (212) 555-9876 | Address Book 1101 |
| 4 | Business Hours | 8 am-6 pm | Yellow Pages |
| 5 | Business Review | **** Great Tailor! | Online Review |
| | | On Time, Every Time | |

At index 1, the information is the same as in table 14 and FIG. 11a.

At index 2, the information that was contained at index 2 of table 14 and FIG. 11a has been changed. Whereas previously the information failed to comprise a zip code for the business address, the information has now been supplemented with information from a provider database. For example and without limitation, this provider database may be one from the contact information database 502 in FIG. 5, or another database that provides contact information.

This particular illustration of the illustrative embodiment of the present invention shows that the data is aggregated and combined to a useful form for a user to digest. At index 2, the addition of the zip code provides more accurate address information for a user.

At index 3, the information is the same as in table 14 and FIG. 11a.

At index 4, the information is new and completely different than the information in table 14 and FIG. 11a. The information about business hours is taken from a “Yellow Pages” database. It will be clear to one skilled in the art, after reading this disclosure, how to make and use alternative embodiments of the present invention in which the information source is a different information source, for example and without limitation, information provided by the business itself, the provider database, another online information source, such as Google or Yelp, etc.

At index 5, the information is new and completely different than the information in table 14 and FIG. 11a. The information about business hours is taken from a “Online Review” source. Examples of these sources include, but are not limited to: Google (as well as Google Local, Google+, etc.), Yelp, individual web sites and blogs that provide reviews, etc.

In accordance with an illustrative embodiment of the present invention, logical and/or probabilistic rules can be defined to assist in the aggregation of contact information. In one example, if two or more pieces of contact information match between contacts from different sources (e.g., phone numbers and e-mails match, names and birthdays match), the contacts can be merged. In another example, the system can use well-known natural language processing, statistical clustering, and/or edit distance calculation techniques to merge contacts that are likely to be for the same person or organization.

It will be clear to one skilled in the art, after reading this disclosure, how to make and use other implementations of the present invention in which one or more of the steps are omitted or are performed in a different order than the one presented or simultaneously.

It is to be understood that the disclosure teaches just one example of the illustrative embodiment and that many variations of the invention can easily be devised by those skilled in the art after reading this disclosure and that the scope of the present invention is to be determined by the following claims.

What is claimed is:

1. A method comprising:
transmitting, from a first telecommunications terminal, a first query comprising a first request for contact information;
receiving, at a first data-processing system, the first query; and
transmitting, from the first data-processing system to the first telecommunications terminal, a response to the first query comprising:
(i) contact information received from the first telecommunications terminal, and
(ii) contact information from the first data-processing system.

2. The method of claim 1 further comprising:
receiving, at the first data-processing system, contact information from a second telecommunications terminal; and
wherein the response to the first query further comprises contact information from the second telecommunications terminal.

3. The method of claim 1 further comprising:
receiving, at the first data-processing system, contact information from a second data-processing system; and
wherein the response to the first query further comprises contact information from the second data-processing system.

4. The method of claim 1 wherein the response to the first query is based on the time of the first query.

5. The method of claim 1 wherein the response to the first query is based on a relationship between the user of the first telecommunications terminal and a user of a second telecommunications terminal.

6. The method of claim 1 wherein the response to the first query is based on a relationship between the telecommunications terminal and the second data-processing system.

7. The method of claim 1 wherein the response to the first query is based on a distance between the telecommunications terminal and an address in the contact information received at the first data-processing system.

8. The method of claim 1 wherein the response to the first query is based on a value assigned to the response to the first query.

9. The method of claim 1 wherein the response to the first query is based on privacy settings.

10. The method of claim 1 wherein the response to the first query is based on a second query from a second telecommunications terminal.

11. A method comprising:
receiving, at a first data-processing system, a first query; and
transmitting, from the first data-processing system to a first telecommunications terminal, a response to the first query,
wherein the response to the first query is based on contact information from the first data-processing system.

12. The method of claim 11 wherein the response to the first query is further based on the time of the first query.

13. The method of claim 11 wherein the response to the first query is further based on a second query received from the first telecommunications terminal.

14. The method of claim 11 wherein the response to the first query is further based on a response to a second query,
wherein the second query is transmitted, from the first data-processing system, to a second data-processing system.

15. The method of claim 11 further comprising:
receiving, at the first data-processing system, information from a second data-processing system; and
wherein the response to the first query is further based on the information received from the second data-processing system.

16. The method of claim 15 wherein the response to the information received from the second data-processing system is in response to a second query sent from the first data-processing system.

17. A method comprising:
transmitting, from a first data-processing system, a first query comprising a first request for contact information;
receiving, at a second data-processing system, the first query;
transmitting, from the second data-processing system, a response to the first query comprising contact information; and
transmitting, from the first data-processing system, a signal to a first telecommunications terminal comprising:
(i) contact information received from the second data-processing system, and
(ii) contact information from the first data-processing system.

18. The method of claim 17 further comprising:
transmitting, from a first data-processing system, a second query comprising a second request for contact information;
receiving, at a second telecommunications terminal, the second query;
transmitting, from the second telecommunications terminal, a response to the second query comprising contact information; and
wherein the signal transmitted to the first telecommunications terminal further comprises the contact information received from the second telecommunications terminal.

19. The method of claim 17 further comprising:
transmitting, from a first data-processing system, a second query comprising a second request for contact information;
receiving, at a third data-processing system, the second query;
transmitting, from the third data-processing system, a response to the second query comprising contact information; and
wherein the signal transmitted to the first telecommunications terminal further comprises the contact information received from the third data-processing system.

20. The method of claim 17 wherein the signal sent to the first telecommunications terminal further comprises contact information received from the first telecommunications terminal.
